(19) United States
(12) Patent Application Publication
(10) Pub. No.: US 2014/0257864 A1
(43) Pub. Date: Sep. 11, 2014

(54) WILDFIRE MITIGATION SERVICES IN-NETWORK APPROACH WITH AN INSURANCE POLICY

(71) Applicant: Wildfire Defense Systems, Inc., Red Lodge, MT (US)

(72) Inventor: Bradly Jay Billman, San Antonio, TX (US)

(73) Assignee: Wildfire Defense Systems, Inc., Red Lodge, MT (US)

(21) Appl. No.: 13/828,089

(22) Filed: Mar. 14, 2013

Related U.S. Application Data
(60) Provisional application No. 61/726,976, filed on Nov. 15, 2012.

(51) Int. Cl. G06Q 40/08

(52) U.S. Cl. CPC G06Q 40/08
USPC 705/4

(57) ABSTRACT

Methods and systems provide mitigation insurance and a network of service providers who perform the mitigation work at a discount rate for members who own mitigation insurance policies. Through mitigation insurance, embodiments of the present invention provide predictable, negotiated price for mitigation services and qualified service providers to the members of an insurance company. According to an embodiment, the mitigation insurance may provide a basic level of mitigation service to reduce a wildfire risk associated with a home by removing or modifying mitigatable items that act as fire fuels on and around the home. The mitigation insurance policy may be offered through an application on a mobile computing device which is implemented to survey homes and to interact with a server computer operated by the insurance company.

### CROSS-REFERENCES TO RELATED APPLICATIONS

This application claims priority to U.S. Provisional Patent Application No. 61/726,976, filed Nov. 15, 2012, entitled “Wildfire Mitigation Services In-Network Approach with an Insurance Policy,” the disclosure of which is hereby incorporated by reference in its entirety for all purposes.

This application is related to U.S. patent application Ser. No. 13/678,301 (Attorney Docket No. US-0827.01|92646-850901) entitled “Mobile Application for Risk Assessment” filed on Nov. 15, 2012; and U.S. patent application Ser. No. 13/678,308 (Attorney Docket No. US-0827.02|92646-850900) entitled “Wildfire Risk Assessment,” filed on Nov. 15, 2012, the disclosure of which are hereby incorporated by reference in their entirety for all purposes.

### BACKGROUND OF THE INVENTION

Customers demand more of the products and services they use than ever before. They insist that the companies they deal with on a regular basis provide them greater and greater levels of accuracy and more tailored service offerings. Companies configure and operate ever increasing numbers of computer systems to achieve this. Using sources of information that have traditionally been unavailable when servicing these customers is now expected.

### SUMMARY OF THE INVENTION

The present invention relates generally to insurance and mitigation service systems. More specifically, the present invention relates to methods and systems for providing a mitigation insurance policy for natural hazards and providing in-network approach with mitigation services. Merely by way of example, the invention has been applied to natural hazard mitigation insurance. More particularly, a wildfire mitigation insurance policy and recommendations for in-network mitigation service providers are provided by embodiments of the present invention. The methods and techniques can be applied to a variety of other forms of insurance, such as homeowners' insurance, renters' insurance, commercial insurance, and the like.

According to an embodiment of the present invention, a method receives mitigation service provider recommendations via a user mobile computing device. The method includes providing a processor, a memory, and at least one sensor in the mobile computing device, surveying features on and around a home by a user to identify mitigatable items using the mobile computing device. The method also includes determining, using the processor, mitigation work required to modify or remove the mitigatable items to reduce a wildfire risk associated with the home and transmitting the information and a request for service providers to a computer system. The method further includes receiving, from the computer system, information related to the service providers who are in the network associated with an insurance company operating the computer system, wherein the information includes a price for performing the mitigation work by the service providers in the network.

According to another embodiment of the present invention, a method provides mitigation insurance for a home. The method includes providing a computer system having a processor, and determining, using the processor, a user who is in need to perform mitigation work for a home to reduce a wildfire risk associated with the home. The method also includes accessing an insurance database to determine that the user does not have a mitigation insurance policy with an insurance company operating the computer system. The method further includes determining, using the processor, an amount of mitigation work required to reduce the wildfire risk associated with the home below a threshold level, and computing, using the processor, a premium amount at least based on the amount of the mitigation work required and the wildfire risk associated with the home. In addition, the method provides an offer to purchase the mitigation insurance on the home to the user wherein the mitigation insurance provides a network of service providers who offer their services at a discount rate.

According to another embodiment of the present invention, a method provides in-network service provider recommendations. The method includes providing a computer system having a processor, receiving information related to mitigation work from a user, and accessing, using the processor, a service provider database including service provider profiles, each of the service profiles being associated with each of service providers in a network associated with an insurance company operating the computer system. The method also includes determining, using the processor, a match between at least a portion of the information related to the mitigation work and a set of service provider profiles. The method further includes transmitting the information related to the mitigation to a set of service providers having the matched set of service provider profiles. In addition, the method includes receiving, from one or more of the set of service providers, an indication of availability to perform the mitigation work, and providing, to the user, information related to the one or more of the set of service providers in the network.

According to another embodiment of the present invention, a mitigation insurance system is provided. The mitigation insurance system includes a data processor, engines, databases, a memory, and a communications module all operatively coupled to the data processor. The communication module and the engines are operably coupled together to perform any of the steps of methods described in the present application.

According to another embodiment of the present invention, a mobile computing device is provided. The mobile computing device includes a data processor, a memory, and a communications module all operatively coupled to the data processor. The mobile computing device also includes a mobile application which is stored in the memory. The mobile application includes a plurality of instructions, which, when executed using the data processor, determine mitigatable items on and around the home and request for mitigation services.

According to another embodiment of the present invention, a non-transitory computer-readable storage medium including a plurality of computer-readable instructions tangibly embodied on the computer-readable storage medium is provided. The plurality of computer-readable instructions, which, when executed by a data processor, perform steps of various methods described herein. In an embodiment, the plurality of instructions are configured to be downloaded to a mobile computing device.

Numerous benefits are achieved by way of the present invention over conventional techniques. For example, embodiments of the present invention provide methods and systems to incentivize a customer to perform mitigation work by reducing cost and efforts required by the customer. Additionally, embodiments of the present invention can provide the customer with recommendations for mitigation service providers and the upfront cost for the mitigation work. This saves time and provides predictability for the total cost since the rates and prices for mitigation services are pre-negotiated by the insurance company. Further, the customer can be assured of the quality of mitigation work performed by service providers in the network associated with the insurance company which has the same goal as the customer—protecting the customer's homes against wildfires and other natural hazards. The customers can benefit by reducing the risk of possible home destruction by catastrophic fire events, and their home values may increase due to preventive maintenance of their homes. An insurance company can also benefit by reducing large payouts and losses due to wildfires. These and other embodiments of the invention along with many of its advantages and features are described in more detail in conjunction with the text below and attached figures.

### BRIEF DESCRIPTION OF THE DRAWINGS

FIG. 1 is a high level block diagram illustrating a mitigation insurance system according to an embodiment of the present invention;

FIG. 2 is a high level schematic diagram illustrating an interaction of a mitigation insurance system with a user and service providers according to an embodiment of the present invention;

FIG. 3 is a high level flowchart illustrating a method of receiving information related to service providers according to an embodiment of the present invention;

FIG. 4 is a high level flowchart illustrating a method of offering a mitigation insurance policy according to an embodiment of the present invention;

FIG. 5 is a high level flowchart illustrating a method of recommending service providers according to an embodiment of the present invention; and

FIG. 6 is high level schematic diagram illustrating a computer system including instructions to perform any one or more of the methodologies described herein.

### DETAILED DESCRIPTION OF SPECIFIC EMBODIMENTS

Embodiments of the present invention relate to technologies to facilitate homeowners and/or renters in finding, acquiring, insuring, and/or maintaining real property. Technologies related to embodiments of the present invention support a homeowner/renter, for example, a member of the present assignee, with the initial preparation associated with the purchase of a home and/or rental of a home/apartment. Such initial preparation can include advice and counseling related to a person's ability to afford a home or apartment, development of a financial plan to facilitate the acquisition, web-enabled self-service systems (e.g., home purchase calculators) used to determine financial goals and requirements, and/or on-line member communities related to homeownership and/or rental.

After a person completes initial preparation, technologies related to embodiments of the present invention assist the person in finding suitable properties through the use of rent/buy listings including information tailored to each person's interests and background. For example, pre-approval of the person for mortgage rates and/or homeowner's/renter's insurance can be used to provide rich information content as part of the search process. On-line member communities can be used to assist users in finding property that is suitable for the particular user's interests and income.

Additionally, technologies related to embodiments of the present invention provide for assistance in the purchase/rental transaction, including obtaining a mortgage and provision of assistance in negotiating the purchase or lease. Protection of the newly acquired home or rented property is also related to embodiments of the present invention, in one of several forms including homeowner's insurance, mortgage life insurance, renter's insurance, flood insurance, personal property insurance, home security systems, home warranties, and the like.

Moreover, technologies related to embodiments of the present invention provide a person with assistance in moving to, maintaining and/or renovating, and/or refinancing the newly purchased or rented property. Thus, embodiments of the present invention relate to technologies that provide a one-stop home resource for delivering home solutions related to buying, selling, renting, and/or owning real property. In particular embodiments, members of a membership organization (e.g., the present assignee) utilize the methods and systems described herein to manage their real property interests and interact with other community members to enable new concepts related to homes and other real property.

Embodiments of the present invention relate to technologies for receiving information related to mitigation work required to reduce a wildfire risk associated with customers' homes and providing recommendations for in-network service providers who are qualified to perform the mitigation work. Embodiments of the present invention also provide mitigation insurance for customers, thereby reducing cost, time, and efforts required to perform mitigation work to reduce wildfire risks associated with homes.

Homes are subject to many natural hazards including wildfires. Although wildfires cannot be prevented, there are some preventive measures that homeowners can undertake to mitigate wildfire risks. For example, providing a defensible space zone, which is cleared of fire fuels, can protect a home from an approaching wildfire. Although the homeowners can prevent or reduce a potential loss due to wildfires, they are not motivated to conduct mitigation work on their homes due to cost, time, and efforts required to perform mitigation work. For example, homeowners need to meet with several contractors to obtain bids, which can be time consuming. Further, there is no protection or guarantee for receiving the best price through the bids or the best quality of work. Even after a wildfire risk inspection and receiving recommendations, homeowners may not be motivated into action due to cost. Embodiments of the present invention provide mitigation insurance and in-network service providers for customers, thereby reducing the gap in cost, time, and efforts required to perform mitigation work to reduce wildfire risks associated with their homes.

The value of mitigation work may be difficult for a consumer to appreciate or quantify. The reduction of risk associated with mitigation work and mitigation insurance may be difficult for a consumer to appreciate due to the unavailability of statistics, lack of experience, or due to lack of understanding of the risk involved. Embodiments of the present invention provide a consumer with value metrics that allow the consumer to make a more rational and calculated decision regarding mitigation work and mitigation insurance. Embodiments of the present invention may provide the consumer with statistics about the reduced risk associated with mitigation work, discounts on other types of insurance, and/or the like.

In embodiments of the present invention, service providers (e.g., lawn and tree care services, landscape services, maintenance, repair, construction, or the like) are placed in a network associated with an entity such as an insurance company. The service providers who have opted into the network are required to limit the cost of certain services for members of the mitigation insurance. In an embodiment, homeowner's or renter's insurance policy can be augmented with a rider that specifically focuses on wildfire mitigation work. In another embodiment, mitigation insurance can be purchased separately from homeowner's or renter's insurance policy. In an embodiment, by paying a low cost premium associated with mitigation insurance, customers have the opportunity to use service providers in the network at a reduced price to perform mitigation work periodically (e.g., annually or biannually).

As described more fully throughout the present specification, embodiments of the present invention provide mitigation insurance for customers and recommendations for in-network service providers who can perform mitigation work for the customers at a discounted rate. Additional description related to these embodiments is provided throughout the present specification and more particularly below. The figures described in this application are used to illustrate embodiments of the present invention, and are not in any way intended to be restrictive of the broad invention. Embodiments of the present invention are not limited to specific arrangements and constructions shown and described. For example, features shown in one figure can be combined with features shown in other figures. Similarly, embodiments described in one section can be combined with embodiments described in other sections of the present application.

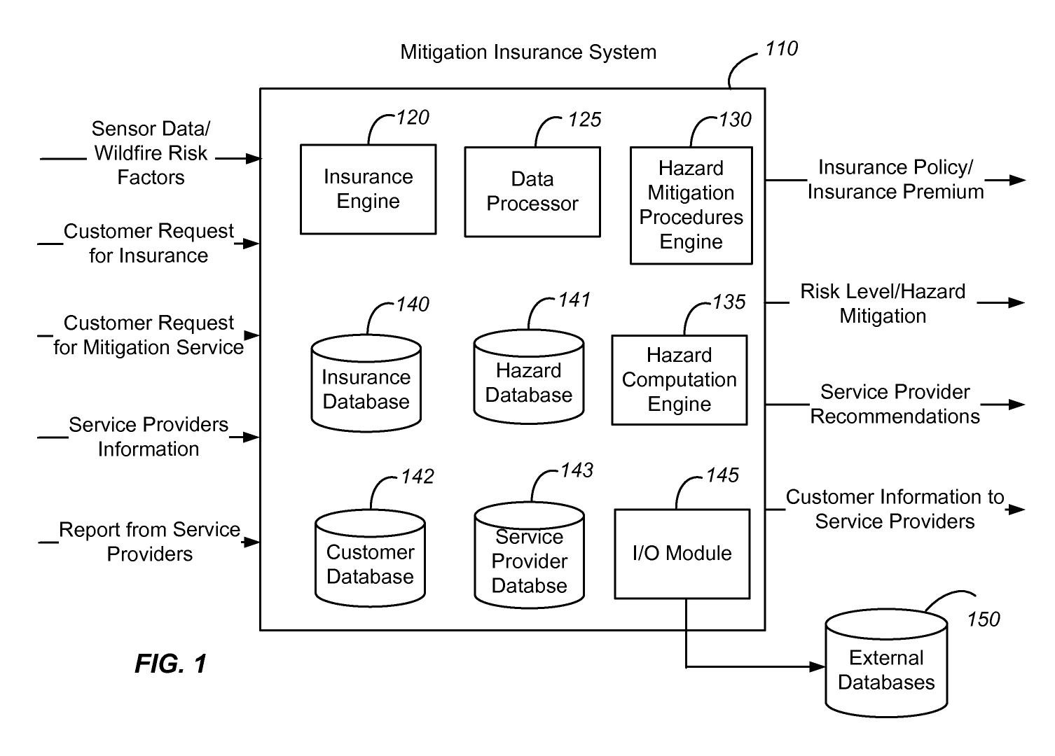

FIG. 1 is a high level block diagram illustrating a mitigation insurance system 110. As illustrated in FIG. 1, a mitigation insurance system 110 may receive information from customers and service providers. From customers, the mitigation insurance system 110 may receive surveyed information including sensor data related to customers' property and surroundings, requests for mitigation insurance, and requests for mitigation work to be performed by third party service providers. In scenarios where the customer decides to perform mitigation work on their own, the system 110 may receive reports, information, documentation, and the like about the details of the work performed. From mitigation work service providers, mitigation insurance system 110 may receive information about their service and reports after performing customers' mitigation work.

Utilizing the illustrated inputs, a data processor 125, an insurance engine 120, a hazard computation engine 135, and a hazard mitigation procedures engine 130 may interact with an insurance database 140, a hazard database 141, a customer database 142, a service provider database 143 and/or external databases 150 to facilitate various computations. For example, the insurance engine 120 can determine insurability of customers based on input data and data retrieved from the databases. The hazard computation engine 135 can determine a risk level of a natural hazard risk (e.g., a wildfire risk) associated with customers' homes using received inputs and data retrieved from the databases. The hazard computation engine 135 may determine the benefits or risk reduction associated with performing mitigation work. The hazard mitigation procedures engine 130 can determine mitigatable items, mitigation procedures, and suitable service providers with matched profiles for mitigation work requested by the customers.

After analyzing the inputs, the mitigation insurance system 110 may provide various outputs: a mitigation insurance policy with an insurance premium for a customer; a risk level of a wildfire risk associated with a home; mitigation procedures, and service provider recommendations based on the customer's needs. The output may also include customer information to service providers whose profiles match mitigation work requested by the customers.

The mitigation insurance system 110 includes a number of databases as shown in FIG. 1. The insurance database 140 stores information related to insurance policies held by a customer. The insurance database may also contain information regarding the coverage, dates, deductibles, claims, insurance claim history, and/or payments associated with various insurance policies issued by the insurance company associated with the mitigation insurance system 110. The insurance database may also contain information regarding any valuation, liabilities, and/or the like associated with the property for which the mitigation insurance is issued. The hazard database 141 stores information related to hazardous conditions associated with specific properties or broader areas (e.g., neighborhood, city, zip code, county, or the like). For example, the hazard database 141 may store information related to wildfire risk factors associated with customers' homes.

The customer database 142 stores data on customers/members of an organization, which may include both existing customers and/or potential customers of an insurance company. The user of the term “member” is not intended to limit the scope of the present invention but merely to provide an example of a customer who may be benefited by embodiments of the present invention. In this sense, the use of the term member is intended to cover the term customer. The data on the member/customer may include a member's name, address, date of birth, Social Security number, credit history, and other demographic information, information regarding insurance policies held by the member, purchase history, information regarding the member's financial accounts held by the member, or the like.

The service provider database 143 stores data on in-network service providers associated with an insurance company operating the mitigation insurance system 110. The stored data may include various service profiles, such as names of service providers, their contact information, their location, description of their service, hours of service, license or certification information, customer review, their pricing and rates, length of time as service providers in the network, or the like. Although the service provider database 143 is shown to be included in the mitigation insurance system 210 operated by the insurance company, the service provider database 143 can be maintained by a third party affiliated with the insurance company.

External databases 150 may be operated by third party entities, such as third party insurance companies, the government, or the like. The external databases 150 may contain external data that may not be included in the surveyed or sensor data captured by a customer in accordance with embodiments of the present invention. For example, the external data related to a risk of a natural hazard associated with the home can include data layers from geographical information system (GIS). External databases may also include data related to environmental conditions such as drought conditions, lightning conditions, storm surge risk data, historical fire data, or the like that may increase wildfire risks for a specific piece of property or for a greater area surrounding the property.

The mitigation insurance system 110 may include a data processor 125. The data processor 125 may be one or more computer processors. The data processor 125 may be part of a computer system that interacts with various components of the mitigation insurance system 110. The data processor 125 may access the insurance database 140, the hazard database 141, the customer database 142, and the service provider database 143. The mitigation insurance system may also include an I/O module 145. The I/O module 145 may allow for communication with various external databases 150. It should be understood that while a connection is shown from the I/O module 145 to the external databases 150, communication may occur via one or more networks.

While the mitigation insurance system 110 can also include other databases, engines, modules, subsystems, or the like, these components are not illustrated in FIG. 1. It should be also understood that the various databases and engines of the mitigation insurance system 110 may be combined or divided into fewer or more databases and engines. The mitigation insurance system 110 is an exemplary embodiment only and is not intended to limit the configuration or components of other embodiments of mitigation insurance systems.

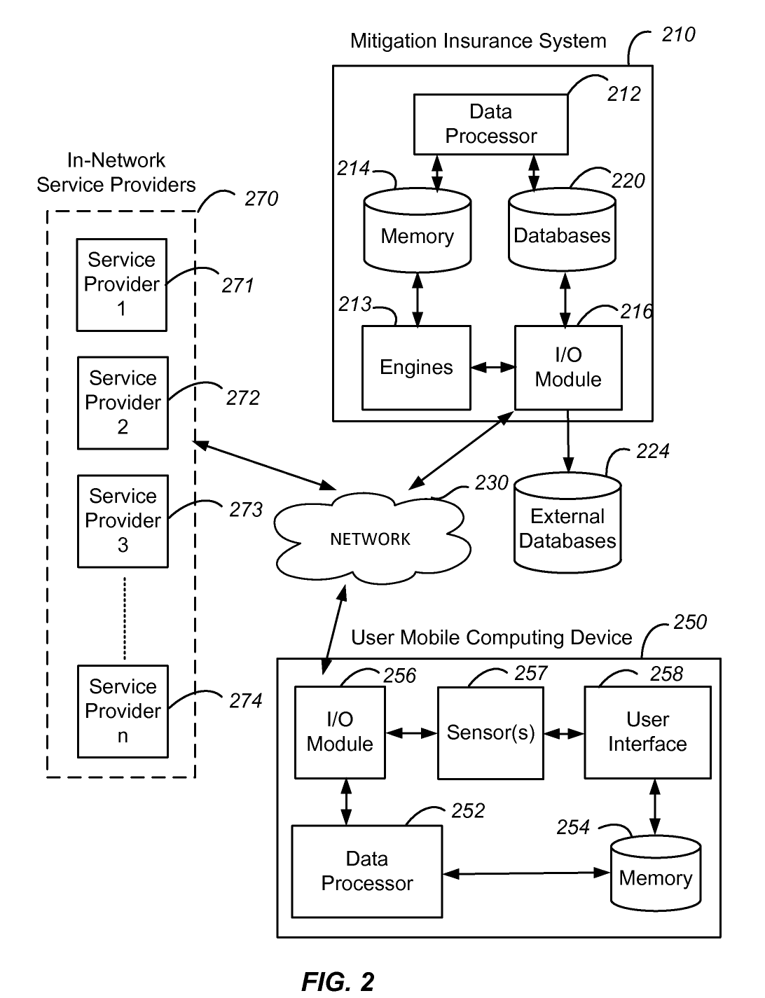

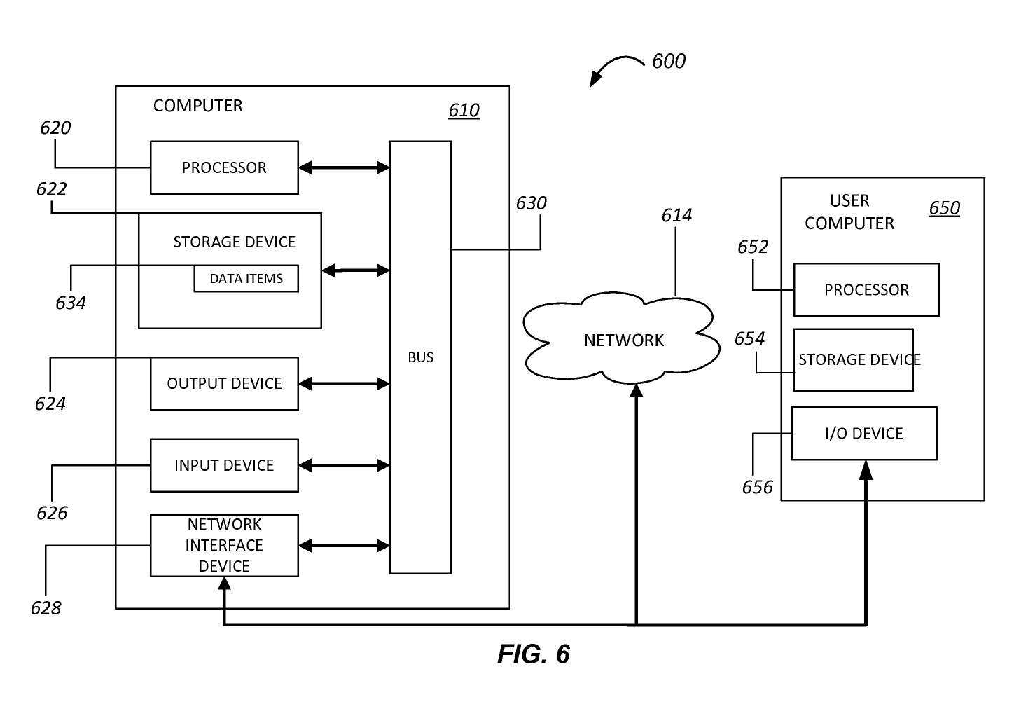

FIG. 2 is a high level schematic diagram illustrating an interaction of an mitigation insurance system 210 with a user and service providers according to an embodiment of the present invention. As shown in FIG. 2, the mitigation insurance system 210 includes a data processor 212, also referred to as a processor, a memory 214, engines 213 (e.g., different engines shown in FIG. 1), databases 220 (e.g., different databases shown in FIG. 1), and an I/O module 216. The description provided in relation to processors and memory in FIG. 6 is also applicable to the data processor 212 and memory 214. The I/O module 216 (also referred to as a communications module) is provided to enable communication between the mitigation insurance system and external users, mobile computing devices, computers, sensors, or the like.

A user can interact with the mitigation insurance system 210 using a user mobile computing device 250 through network 230. The mobile computing device 250 can include a handheld mobile phone (e.g., iPhone™ or Android™ smart phones), a handheld mobile device (e.g., iPod Touch™), a tablet (e.g., iPad™), a PDA, a notebook computer, or the like. The mobile computing device 250 may run one or more applications specifically implemented to communicate with the mitigation insurance system 210 or may use an internet browser to do so. A user can use one or more websites to communicate with the mitigation insurance system 210. Websites may be operated directly by the insurance company operating the mitigation insurance system 210 or may be operated by a third party vendor of the insurance company. Also, while not illustrated in FIG. 2, in some embodiments, the user can interact with the mitigation insurance system via other interfaces, such as Interactive voice response (IVR)/operator system or agent locations. While an embodiment shown in FIG. 2 illustrates the use of a mobile computing device, any user computers including a desktop computer may be used to interact with the mitigation insurance system 210.

In an embodiment illustrated in FIG. 2, the mobile computing device 250 has a data processor 252, a memory 254, an I/O module 256, sensor(s) 257, and user interface 258. The mobile computing device can receive responses such as requests for additional information from the mitigation insurance system 210, process the received information using the data processor 252, store the received and/or processed information using the memory 254, and display the processed/stored information using the user interface 258.

In an embodiment illustrated in FIG. 2, the mobile computing device 250 has one or more sensors 257 in the user computing device 250 that can collect sensor data on and around the user's home. For example, a camera may be included as sensors 250 in the mobile computing device 250 to collect sensor data such as videos, photos, other images of features that may enhance a wildfire risk for the home. In another example, a GPS receiver may be included as a sensor to mark locations of mitigatable items or a defensible space zone around the home.

Mitigatable item can be objects or features that can be modified or removed by a person or machine at a reasonable cost and man power, as part of a routine maintenance or an upgrade of a home to reduce a wildfire risk associated with a home. Examples of mitigatable items include flammable dry bushes and trees which can be cut or dry leaves in the gutter which can be removed. Another example of mitigatable items is roof opening vents (through which embers can enter) that can be shielded. By contrast, if the home is located within a forest of dense vegetation, the forest is not considered as a mitigatable item since it cannot be removed at a reasonable cost.

A defensible space zone is an area within a perimeter of a home where basic wildfire (or other natural hazard) protection practices are implemented, thereby providing key points of defense from an approaching wildfire. Generally, a defensible space zone is an area within about 30 feet of a home at a minimum, typically within about 100 feet of a home (or a building or a structure). As used herein, a vicinity of a home can also refer to an area surrounding a building and can also include the exterior portion or features of the building.

In embodiments of the present invention, other types of sensors can also be included or operatively coupled to the mobile computing device. In some embodiments, sensors that are not incorporated in the mobile computing device 250 can be deployed around the home for additional sensor measurements. Sensor data and other information obtained by the mobile computing device 250 can be stored in the memory 254 and can be transmitted to the mitigation insurance system 210 for further analysis. Additional detail related to obtaining sensor data and information related to mitigatable items are described in a copending U.S. patent application Ser. No. 13/678,301, filed on Nov. 15, 2012, U.S. patent application Ser. No. 13/678,308, filed on Nov. 15^{th}, 2012, and U.S. patent application Ser. No. 12/769,563, filed Apr. 28, 2012, the disclosures of which are hereby incorporated by reference in their entirety for all purposes.

In embodiments, specialty sensor devices may be designed to be operable with a user mobile device. A sensor kit may be provided to a customer to perform the initial survey of the area around the property. The customer sensor kit may be configured to provide additional telemetry and sensor options to a customer's mobile device such as a smart phone, tablet, computer, or the like. The customer sensor kit may be configured to operate in conjunction with the customer mobile device through a cable or wireless interface. The customer sensor kit may include sensors and capabilities such as high sensitivity GPS receivers, motions sensors, 3D accelerometers, laser scanners, 3D scanners, infrared sensors, temperature sensors, spectroscopes, chemical sensors, sonar sensors, and the like.

A user operating the mobile computing device 250 interacts with the mitigation insurance system 210 through the network 230, which may be the Internet. In some embodiments, the network 230 is partly or wholly a private wide area network, local area network, or the like. A customer of an insurance company (e.g., a member of the present assignee) can use mobile computing device 250 to interact with the insurance company (e.g., the present assignee) through the Internet, providing and receiving information through web pages operated by the insurance company (e.g., the present assignee's website). Although FIG. 2 illustrates a single network 230, a plurality of networks may be used for communication between apparatuses shown in FIG. 2.

In another example, a customer can download a mobile application stored in the memory 214 of the mitigation insurance system 210 or in other systems on a server to the user's mobile computing device 250 through the Internet. Alternatively, it can be downloaded from third party sources, such as App stores. Through the mobile application installed on the mobile computing device, a user can survey the user's home and interface with the mitigation insurance system 210 or other systems in a server. In yet another example, some of the features in accordance with embodiments of the present invention may be provided by the website and others by a downloaded mobile application.

The mitigation insurance system 210 and the user mobile computing device 250 may also interact with a number of different in-network service providers 270. The in-network service providers are contractors who can perform mitigation work on behalf of homeowners to reduce a wildfire risk associated with homes. To be qualified as an in-network service provider, the in-network service provider has to meet a specific set of standards of certification requirements set forth by the insurance company. The price or rates for their services and products may be negotiated by the insurance company prior to interacting with members of the insurance company. The range of mitigation services provided by individual service provider may vary, and these can include: lawn and tree care services, landscaping services, general repairs, maintenance services, construction services, or the like. In some embodiments, a service provider can survey a home on behalf of a customer to identify mitigatable items that can be removed or modified.

As shown in FIG. 2, there may be a number of different in-network service providers 270: Service Provider 1 (271), Service Provider 2 (272), Service Provider 3 (273), Service Provider n (274), and additional service providers (not illustrated) in the network 270. Although FIG. 2 illustrates each service provider interacting with the mitigation insurance system 210 and the user mobile computing device 250 via the network 230, the service providers can interact with the insurance company and users through other networks or via other interfaces, such as an IVR/operator system, agents, or the like. Through any suitable interface, information related to service providers (e.g., hours of service or rate) or reports after performing mitigation work can be provided to the mitigation insurance system 210. In addition to performing mitigation work, a service provider may survey or inspect a home on behalf of the customer in some embodiments. For example, a service provider may use user mobile computing device 250 on behalf of a customer to collect sensor data on or around the customer's home to identify mitigatable items.

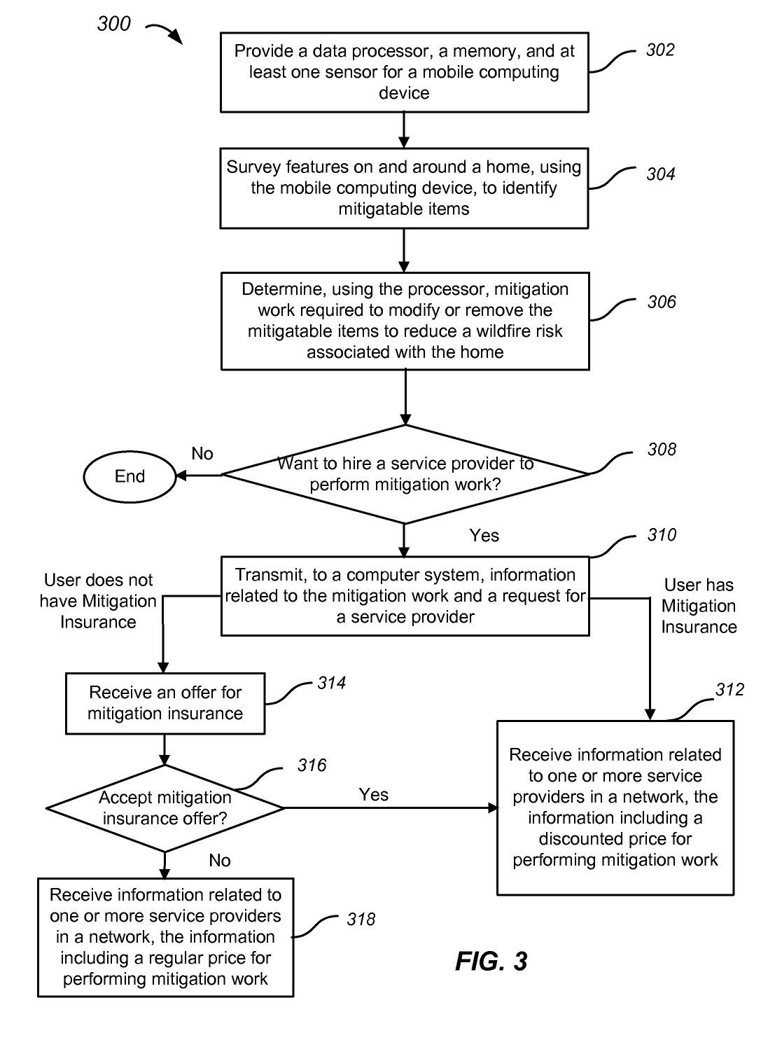

FIG. 3 is a high level flowchart illustrating a method performed by a mobile computing device according to an embodiment of the present invention. In an embodiment illustrated in FIG. 3, the method 300 can be used by a user to identify mitigatable items on and around the user's home using a mobile computing device. The mobile computing device can also be used to receive information related to service providers in the network associated with the insurance company. Further, the method can be used to receive an offer to purchase a mitigation insurance policy which can be used to hire service providers in the network to perform mitigation work at a discounted price.

In an embodiment illustrated in FIG. 3, the method 300 includes providing a data processor, a memory, and at least one sensor, which are operatively coupled to one another, in a mobile computing device (302). As described in relation to FIG. 2, one or more sensors, such as a camera or a GPS receiver, can collect local data useful in determining risk factors of a wildfire associated with homes. As an example, the mobile computing device may include a camera as a sensor which can collect videos, photos, or other images from the vicinity of the property in real-time. In another example, the mobile computing device may include a GPS receiver to receive a GPS signal. The GPS receiver can assist a user in determining a boundary of a defensible space zone for the home and to mark positions of identified mitigatable items in the defensible space zone. In some embodiments, the mobile computing device may include one or more additional sensors, or may be communicatively coupled to additional sensors deployed around the home.

In an embodiment, the mobile computing device 250 may run one or more applications specifically implemented to survey features on and around the home to identify mitigatable items and communicate with mitigation insurance system (304). Through an application on a mobile computing device, features on and around the home can be surveyed. Surveying may include inspecting a home to identify features that may enhance a wildfire risk associated with a home.

In an embodiment, surveying a home can be achieved using an augmented reality tool provided by an application running on the mobile computing device. Through the application, real-world images shown on the screen of the mobile computing device can be overlaid with augmenting data, such as sound, text, graphics, or GPS data. For example, a real view of a backyard can be overlaid with range-finder type lines showing distance markers (e.g., in yards or feet). Typically, the distance markers displayed on the screen show a boundary of a defensible space zone in the backyard (e.g., 10 feet, 30 feet, or 100 feet from the house), which should be cleared of fire fuels.

In some embodiments, an application for surveying the home may include plant identifying technology, object recognition technology, and/or external database of information. For example, the view-finder (camera/video) feature of the application can use object recognition technology to automatically identify risk factors in real-time (e.g., holes in siding of the house) and highlight those areas on the screen. Any mitigatable items can be identified by any suitable object recognition or by the user through the application. Locations of identified mitigatable items can be marked by the GPS receiver incorporated in the mobile computing device. The location so identified items can be stored in a database of the mobile computing device and communicated to the mitigation insurance system.

In some embodiments the navigation position system used to identify mitigatable items around the property may be based on gyroscope navigation. In some locations the accuracy of a GPS receiver may not be accurate enough to perform an accurate survey. In areas or in devices where the GPS receiver does not adequate accuracy data from motion sensors, accelerometers, compasses, and the like may be used instead of GPS or may be used to enhance the position information. Sensing directional and acceleration changes from accelerometers and gyroscopes it is possible to provide to the user an accurate positioning system relative to a known fixed position such as their house, or a known GPS coordinate. In an embodiment using gyroscope navigation the customer may be first asked to walk around the perimeter of their house with the device to get a base position of the building on the property. Once the relative position of the building is know the customer may be prompted to walk to the mitigatable items such as trees or brushes around their house allowing the device to capture their location relative to the location of the building.

In another embodiment, a set of questionnaires can be used to guide a user to survey and inspect the home systematically. Through an application running on the mobile computing device, a plurality of questions related to features about the home, yard, and surrounding areas of the home can be presented. For example, questions may include: “Does your home have wood or vinyl siding, or any combination including these materials?”; “Do the sides of your home any openings?”; “Does your home have gutters and are they free of debris?”; “Do you have any of the following materials near your home: leaf piles, a propane tank, building materials, storage items, or wood/rubber mulch?”; or the like. The total number of questions presented to the user is less than fifty, typically less than thirty, more typically less than twenty, so that a homeowner is more likely to finish inspecting the home within a reasonable amount of time (e.g., 20 minutes). The user's answers to these and other questions can be used to educate and guide the user in determining risk factors of a wildfire associated with the home.

If images are helpful in assessing risks posed by certain features inquired in the questionnaire, an instruction may be provided to the user to capture images of these features. In an embodiment, augmented visual assistance can be optionally provided on the screen of the mobile computing device through an application. The augmented visual assistance can be visual information that can be graphically overlaid on top of a real view image on the screen so that it can be used as a guide for a user to capture a proper image of a feature. For example, augmented visual assistance can include a compass bearing, a level graphic to show proper angles/or distance at which a picture of a feature should be taken. In another example, augmented visual assistance can be in the form of a “magic window” or a graphically augmented assistance window, which has a boundary so that a feature of interest can be fit within the boundary when capturing images.

After surveying features on and around the home, the method (300) includes determining, using the processor, mitigation work required to modify or remove the mitigatable items to reduce a wildfire risk associated with the home (306). The mitigation work may include removing identified mitigatable items, such as removing dry vegetation within a defensible space zone of a home, removing debris from the gutter, removing wood mulches and bushes nearby windows, or the like. The mitigation work may also include modifying identified mitigatable items, such as trimming tree limbs hanging over the roof, shielding open vents on the exterior of a home, adding a fire resistant coating on a vinyl siding, or the like. The mitigation work may further include replacing or upgrading certain features, such as replacing single pane windows with double pane windows, replacing a wood shingle roof with a composite shingle roof, or the like.

In some embodiments, the surveyed data can be transmitted to the mitigation insurance system or a third party, such as a professional inspection service company, which in turn, can analyze the data to determine mitigation work required to reduce the wildfire risk associated with the home. In other embodiments, the user can provide a real-time video feed or images over an area of concern, through the mobile computing device, and interact with professionals. For example, the user can consult with experts, such as professional wildfire fighters, associated with the insurance company or experts in plant species identification to receive their feedback in real-time.

In embodiments, after the customer finishes the initial mitigation survey, the system may receive the information from the customer's device and calculate an initial estimate for the costs associated with the mitigation work. The system may calculate an estimate of a range of fees associated with the mitigation costs based on the number of items located, their distance to buildings, height, types of items, geographical location, and the like. The system may present to the user an average cost of mitigation services for similar properties in the vicinity of the customer's home. The customer may decide to forward the information to one or more service providers to obtain a more accurate estimate from each provider based on the information provided.

After the required mitigation work is determined by the application, the mitigation insurance system, or the third party, recommendations for mitigation work are displayed on the screen of the mobile computing device. In an embodiment, recommendations for mitigation work can be prioritized based on the impact that each piece of project will have on the overall wildfire risk associated with the home. In another embodiment, recommendations can be prioritized based on the user's budget.

In embodiments the recommendations may be displayed with mitigation cost estimates, insurance cost estimate, premium savings estimates, risk reduction, or other statistical data. The customer may be presented with the direct costs of performing the mitigation work along with one or more direct or indirect benefits and savings the customer may receive for performing the mitigation work. For many customers it may be difficult to quantify the value of the mitigation work, the system may present the user with a summary of the potential value of the work. The benefits of performing the mitigation work may be reflected in a reduction of premiums on a customer's home insurance, or car insurance for example. For some customers, the value of the mitigation work may be captured with statistics regarding the possible reduction of fire risk. The risk assessment may be provided by showing the possible reduction of risk with respect to the size of safety perimeter or border that is maintained around a building. To obtain meaningful statistics the system may, for example, query a database of customers who performed mitigation around the home and compare their fire incident claim rate compared to those customers who did not perform mitigation work. With enough database members the comparison may provide an estimate of a possible reduction in fire risk. The system may report to the customer information such as “Customers who maintained a mitigation area of 50 feet around the house had 20% fewer fire incident claims than those who did not perform mitigation.”

The method 300 also includes querying, via the mobile computing device, whether the user wants to hire a service provider in the network associated with the insurance company to perform the mitigation work (308). If the response is no, then the method 300 ends, and it is assumed that the homeowner will personally perform the mitigation work. If the response is yes, the request from the user for a service provider is transmitted to the mitigation insurance system (310). The request may include a time frame for performing the mitigation work, geographic location of service providers, a maximum price that the user is willing to pay for mitigation work, or the like. In some embodiments, the mitigation insurance system will correlate the needs of the user with a plurality of service providers in the network to provide a best matched set of service providers to the user.

If the customer decides not to hire a service provider to perform the mitigation work the system may optionally show or direct the user to information related to performing mitigation work. The information may include local rules or regulations regarding removal of trees or other plants on a property. In some areas, for example, a permit may be required to remove trees. In some areas, it may be necessary to obtain approval of a local electrical company in order to secure overhead power lines or check for underground cabling. The system may present the user with links or contact information so that the user may obtain such permits and approval if necessary. In some areas, specific plants or trees may be endangered, protected, or the plants and trees may be home to endangered or protected insects or other wildlife. The system may present such information to the user along with optional literature and/or pictures to ensure any mitigation work by the user is performed in a responsible and environmentally conscious manner.

If the user already has a mitigation insurance policy with the insurance company operating the mitigation insurance system 210, the method 300 includes receiving, at the mobile computing device, information related to one or more service providers in the network whose services are offered at a discounted rate (312). For example, compared to customers who do not have mitigation insurance, services of in-network service providers can be provided to insured customers at a discounted rate, such as 10, 20, 30, 40, or 50 percent lower than a regular rate typically offered by the service providers. The discounted rate can apply to products, services, or both required for the mitigation work. Other information that can be received include service providers' contact information, availability of time to perform mitigation work, reviews of service providers by other customers, the total price for performing mitigation work, or the like.

If the user does not have a mitigation insurance policy with the insurance company, then the method 300 includes receiving an offer to purchase a mitigation insurance policy at the mobile computing device (314). The mitigation insurance policy provides customers with an access to a network of service providers, whose service rates have been previously negotiated by the insurance company, provide mitigation services to insured customers at a discounted rate. A mitigation insurance policy may be offered as a separate insurance policy or as a rider to the user's homeowner's or renters' policy. In an embodiment, the mitigation insurance policy may include a basic mitigation service, such as trimming of dry bushes within a certain boundary or inspecting homes once or twice per year.

The premiums for mitigation insurance policies may be based on results of surveyed features on and around the home. The premium amount will be higher if it is determined, through surveying the home, that there are a large number of mitigatable items that need to be removed or modified periodically compared to homes with a smaller number of mitigatable items. In an embodiment, the annual premium for the mitigation insurance policy is fixed. In another embodiment, an adjustable and variable premium which fluctuates over time may be provided. For example, if a customer or a service provider certifies that the mitigation work has been completed, the mitigation insurance premium may be adjusted and discounted to a lower price for a fixed period of time (e.g., 6 months). The premium may be re-adjusted according to the customers' ongoing mitigation efforts.

If the user accepts the offer for a mitigation insurance policy (316), then the mitigation insurance policy with an appropriate premium amount is issued to the user. Based on the mitigation work transmitted by the user, the user also receives information related to one or more service providers in the network who can perform mitigation work for the user at a discounted rate (312). If the user does not accept the offer for the mitigation insurance policy (316), then the information related to one or more service providers in the network transmitted from the mitigation insurance system may be received at the mobile computing device according to an embodiment of the present invention. However, the information may include regular rates or prices offered by service providers in the network for non-insured customers (318). After reviewing the information related to service providers in the network, the user can select one or more of the service providers to perform the mitigation work required to reduce a wildfire risk associated with the user's home.

It should be appreciated that the specific steps illustrated in FIG. 3 provide a particular method of providing in-network service providers for mitigation work according to an embodiment of the present invention. Other sequences of steps may also be performed according to alternative embodiments. For example, alternative embodiments of the present invention may perform the steps outlined above in a different order. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize many variations, modifications, and alternatives.

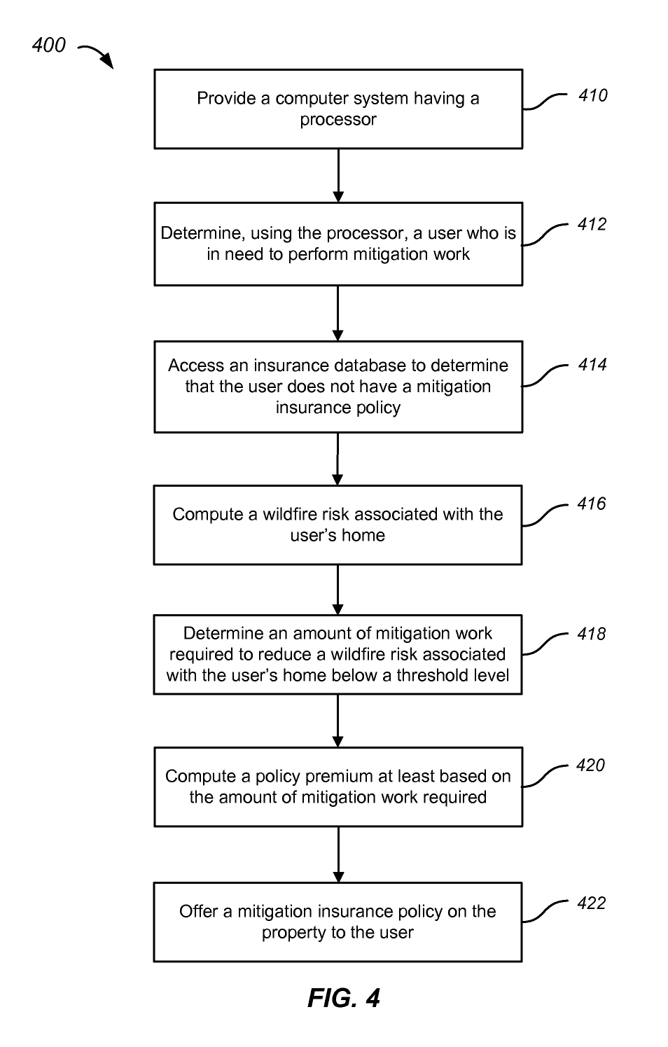

FIG. 4 is a high level flowchart illustrating a method of providing a mitigation insurance policy according to an embodiment of the present invention. A method 400 includes providing a computer system having a processor (410). In an embodiment, the computer system can be the mitigation insurance system 110 shown in FIG. 1. In the method 400, it is determined by the processor a user who is in need to perform mitigation work (412). For example, after surveying a user's home using a mobile computing device as described in relation to FIG. 3, a request for service providers may be transmitted from the user and received at the computer system.

In some embodiments, an insurance database may be accessed by the processor to identify customers who may have a need for mitigation insurance. The system may use a variety of factors and a data sources to determine which members may benefit from mitigation insurance. Customers living in high brush zones or wildfire risk zones may be identified as in need of periodic clearing of dry bushes and trees in their defensible space zone surrounding their homes. Customer and property data such as the amount of land a property has, if a house has a garage, the age of the member, and the like may be used by the system to identify members. For example, a house with two or more acres of property but with no garage may signal a customer with a need for mitigation service since without a garage it may be unlikely that the customer may have the proper tools to perform mitigation work and may be in need of a third party to perform such work.

After determining users who may be in need to mitigation work, the insurance database is accessed to determine users who do not have mitigation insurance policies (414). For customers who do not own mitigation insurance policies, their homes and customers' profiles can be further analyze to determine if they are suitable candidates for offering mitigation insurance policies. For example, their insurance claims history or payment history may be analyzed. In the method 400, a wildfire risk associated with the user's home can be computed to determine if the user's home is insurable (416). The wildfire risk associated with the home can be determined based on surveyed information transmitted from the user computing device, external databases, or both. A mitigation insurance policy may not be offered to customers who live in homes located in a very high risk zone where mitigation efforts will not significantly reduce wildfire risks associated with the homes.

In the method 400, an amount of mitigation work required to reduce a wildfire risk below a threshold level is determined for the user's home (418). A policy premium can be determined at least based on the amount of mitigation work required to reduce the wildfire risk below the threshold level (420). For example, the threshold level can be clearing of fire fuels, such as dry bushes and trees, within a defensible space zone around the home (e.g., within 30 feet, 60 feet, or 100 feet). In some embodiments, the insurance premium may be dependent on the location of the customers' homes. If a customer lives in a high-risk area with a large amount of plants constantly growing, then the mitigation insurance premium will be higher for such customer than for someone living in a low-risk area, such as desert. Also, the premium cost may also depend on the compliance level with current building codes. For homes built up to the current building codes, the premiums may be less since there is typically less mitigation work required to shield the homes against approaching wildfires.

After computing an insurance premium, a mitigation insurance policy can be offered to the user (422). The mitigation insurance policy allows customers to tap into a wide network of service providers who may be certified by the insurance company and are under contract to offer a discount rate for their services to insured customers. The mitigation insurance policy can also include a basic level of mitigation service such as clearing of dry bushes and trees in a defensible space zone, clearing gutters, or other types of mitigation services periodically (e.g., annually, biannually, quarterly, or the like). In another embodiment, the mitigation insurance policy may not include any basic mitigation service associated with premium payments and may offer services of in-network service providers at a discounted rate. In such an embodiment, the amount of required mitigation work may not be considered as a part of premium computation.

A mitigation insurance policy can be offered in various manners. For example, it can be offered as an independent insurance policy that can be purchased separately from a homeowner's or renter's insurance policy, through a home mitigation club, for example. Thus, non-members of the insurance company can purchase the mitigation insurance since a wildfire is a community issue, not just a homeowner's issue. Alternatively, it can be offered as a rider to augment a homeowner's or renter's insurance policy. When it is offered as a rider, the premium cost is typically lower than the premium cost of an independent insurance policy. In an embodiment of the present invention, a rider may be offered at no additional cost as long as the customer has a homeowner's or renter's insurance policy through the insurance company.

In addition to providing in-network service providers at a discounted rate, a member of the mitigation insurance policy may be offered additional benefits. For example, the member may be offered a delayed payment plan (e.g., a monthly payment plan) for mitigation work performed by service providers. The member may be provided with a billing statement showing the regular rate of a service provider, a reduced rate for being a member, the remaining balance to pay. In another embodiment, a separate bank account can be created as a savings plan for the member so that a portion of the member's income can be automatically transferred to the separate account to pay for the mitigation work. In some embodiments, a portion of the insurance premium may be used as a savings vehicle to pay for the remaining balance for the mitigation work.

Other incentive programs can be provided for members of mitigation insurance policies. When the mitigation insurance system receives an indication that the mitigation work has been completed on the members' property, points or other rewards can be applied in a reward program. The reward program may be used to purchase gift cards, products, or to pay for future mitigation work. In an embodiment, points can be automatically applied to the members' reward accounts when reports of completed mitigation work are received from service providers. The report may include pictures as evidence of completion of mitigation work. In some embodiments, service providers' or members' bank accounts at a bank associated with the insurance company may be monitored so that when the service providers receive a payment from members for the mitigation work, reward points can be automatically applied to the members' reward accounts.

It should be appreciated that the specific steps illustrated in FIG. 4 provide a particular method of providing mitigation insurance according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives.

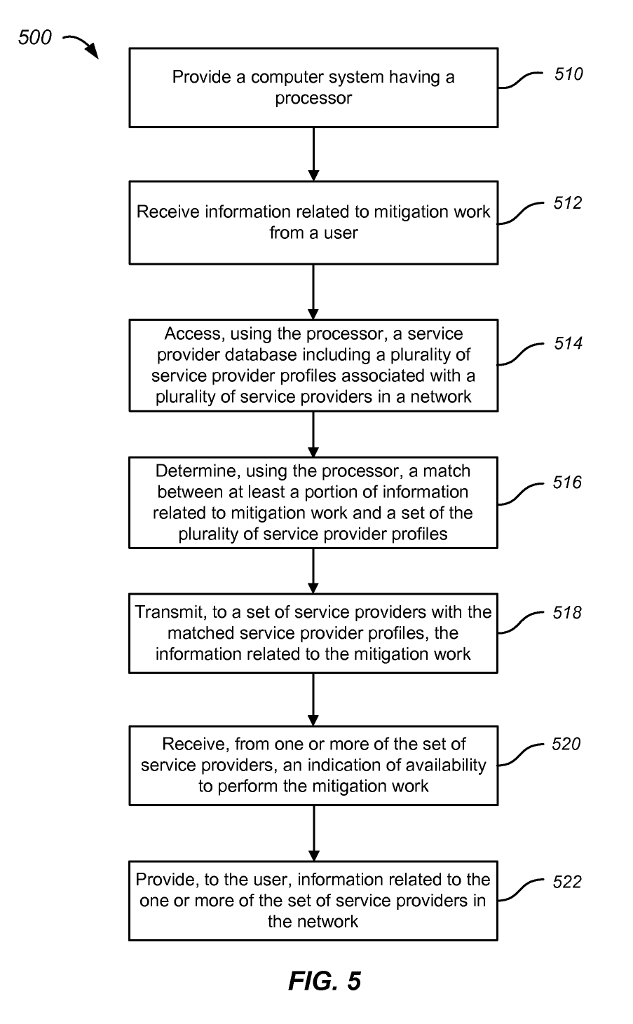

FIG. 5 is a high level flowchart illustrating a method of providing a mitigation insurance policy according to an embodiment of the present invention. A method 500 includes providing a computer system having a processor (510). In an embodiment, the computer system can be the mitigation insurance system 110 shown in FIG. 1. In the method 500, information related to mitigation work is received from a user (512). The information can be received through any suitable user interface, such as a mobile computing device with captured images through a mobile application, a website, IVR/operator system, or agents. The information includes types of mitigation work required (e.g., tree and bush trimming service, screening or shielding open vents, replacing single pane windows, or the like). The information may also include the user's preference for service providers' location, service provider ratings by others, scheduling preferences, or the like. The information may further include the user's budget and the maximum price or rate that the user is willing to pay for services.

Using the processor, the computer system accesses a service provider database which includes a plurality of service provider profiles associated with each of a plurality of service providers in a network (514). A service provider profile may contain a variety of information including each service provider's service specialty, location, rates/prices, ratings by other consumers, hours of operation, or the like. The method 500 includes determining, using the processor, a match between at least a portion of the information related to the mitigation work and a set of the plurality of service provider profiles (516). For example, if the mitigation work requested by the customer requires a tree trimming service, then the processor matches and retrieves service providers in the network providing such services. In another example, if the information related to the mitigation work indicates a customer's preference for service providers in the local area, then such preferences are matched with the service providers' profiles.

After determining a set of suitable service providers with matching profiles, the information related to the customer's requested mitigation work is transmitted to the set of service providers in the network (518). The information includes the type of mitigation work that needs to be performed, any preferences indicated by customers, such as hours of service, price/rate, or materials to be used. Upon transmitting the information to the set of service providers, the method 500 includes receiving, from one or more of the set of service providers, an indication of availability to perform the mitigation work (520). The indication of availability may include their available time schedule to perform the mitigation work, price/rate, other incentives, or the like, to attract the customer to choose their services.

Upon receiving the indication of availability from the service providers, the method 500 includes providing, to the user, information related to one or more of the set of service providers in the network who has indicated their availability to perform the requested mitigation work (522). The additional information, such as contact information, time schedule to perform the work, price/rate, incentives, ratings, or the like, may also be transmitted to the customer to assist the customer in selecting a service provider. The information can be provided to the customer through any suitable mode of communication: a mobile application, an e-mail, a text, a voicemail, or the like. After the customer selects a service provider from the list determined by the mitigation insurance system, the customer and the service provider can communicate with each other through any suitable communication means described in the present application.

It should be appreciated that the specific steps illustrated in FIG. 5 provide a particular method of providing recommendations for in-network service providers according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 6 is a high level block diagram illustrating a computer system including instructions to perform any one or more of the methodologies described herein. A system 600 includes a computer 610 connected to a network 230. The computer 610 includes a processor 620 (also referred to as a data processor), a storage device 622, an output device 624, an input device 626, and a network interface device 628, all connected via a bus 630. The processor 620 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 620 executes instructions and includes that portion of the computer 610 that controls the operation of the entire computer. Although not depicted in FIG. 6, the processor 620 typically includes a control unit that organizes data and program storage in memory and transfers data and other information between the various parts of the computer 610. The processor 620 receives input data from the input device 626 and the network 230 reads and stores code and data in the storage device 622 and presents data to the output device 624.

Although the computer 610 is shown to contain only a single processor 620 and a single bus 630, the disclosed embodiment applies equally to computers that may have multiple processors and to computers that may have multiple busses with some or all performing different functions in different ways.

The storage device 622 represents one or more mechanisms for storing data. For example, the storage device 622 may include read-only memory (ROM), random access memory (RAM), magnetic disk storage media, optical storage media, flash memory devices, and/or other machine-readable media. In other embodiments, any appropriate type of storage device may be used. Although only one storage device 622 is shown, multiple storage devices and multiple types of storage devices may be present. Further, although the computer 610 is drawn to contain the storage device 622, it may be distributed across other computers, for example on a server.

The storage device 622 includes a controller (not shown in FIG. 6) and data items 634. The controller includes instructions capable of being executed on the processor 620 to carry out the methods described more fully throughout the present specification. In another embodiment, some or all of the functions are carried out via hardware in lieu of a processor-based system. In one embodiment, the controller is a web browser, but in other embodiments the controller may be a database system, a file system, an electronic mail system, a media manager, an image manager, or may include any other functions capable of accessing data items. Of course, the storage device 622 may also contain additional software and data (not shown), which is not necessary to understand the invention.

Although the controller and the data items 634 are shown to be within the storage device 622 in the computer 610, some or all of them may be distributed across other systems, for example on a server and accessed via the network 230.

The output device 624 is that part of the computer 610 that displays output to the user. The output device 624 may be a liquid crystal display (LCD) well-known in the art of computer hardware. But, in other embodiments the output device 624 may be replaced with a gas or plasma-based flat-panel display or a traditional cathode-ray tube (CRT) display. In still other embodiments, any appropriate display device may be used. Although only one output device 624 is shown, in other embodiments any number of output devices of different types, or of the same type, may be present. In an embodiment, the output device 624 displays a user interface.

The input device 626 may be a keyboard, mouse or other pointing device, trackball, touchpad, touch screen, keypad, microphone, voice recognition device, or any other appropriate mechanism for the user to input data to the computer 610 and manipulate the user interface previously discussed. Although only one input device 626 is shown, in another embodiment any number and type of input devices may be present.

The network interface device 628 provides connectivity from the computer 610 to the network 230 through any suitable communications protocol. The network interface device 628 sends and receives data items from the network 230.

The bus 630 may represent one or more busses, e.g., USB (Universal Serial Bus), PCI, ISA (Industry Standard Architecture), X-Bus, EISA (Extended Industry Standard Architecture), or any other appropriate bus and/or bridge (also called a bus controller).

The computer 610 may be implemented using any suitable hardware and/or software, such as a personal computer or other electronic computing device. Portable computers, laptop or notebook computers, PDAs (Personal Digital Assistants), mobile phones, pocket computers, tablets, appliances, telephones, and mainframe computers are examples of other possible configurations of the computer 610. For example, other peripheral devices such as audio adapters or chip programming devices, such as EPROM (Erasable Programmable Read-Only Memory) programming devices may be used in addition to, or in place of, the hardware already depicted.

The network 230 may be any suitable network and may support any appropriate protocol suitable for communication to the computer 610. In an embodiment, the network 230 may support wireless communications. In another embodiment, the network 230 may support hard-wired communications, such as a telephone line or cable. In another embodiment, the network 230 may support the Ethernet IEEE (Institute of Electrical and Electronics Engineers) 802.3x specification. In another embodiment, the network 230 may be the Internet and may support IP (Internet Protocol). In another embodiment, the network 230 may be a local area network (LAN) or a wide area network (WAN). In another embodiment, the network 230 may be a hotspot service provider network. In another embodiment, the network 230 may be an intranet. In another embodiment, the network 230 may be a GPRS (General Packet Radio Service) network. In another embodiment, the network 230 may be any appropriate cellular data network or cell-based radio network technology. In another embodiment, the network 230 may be an IEEE 802.11 wireless network. In still another embodiment, the network 230 may be any suitable network or combination of networks. Although one network 230 is shown, in other embodiments any number of networks (of the same or different types) may be present.

A user computer 250 can interact with computer 610 through network 230. The user computer 250 includes a processor 252, a storage device 254, and an input/output device 256. The description related to processor 620 and storage device 622 is applicable to processor 252 and storage device 254. As an example, the user computer 250 can be a personal computer, laptop computer, or the like, operated by a member of a membership organization (e.g., the present assignee). Using the user computer 250, the member can then interact with computer 610 operated by the present assignee through network 230 in order to access the present assignee's web pages or the like.

The embodiments described herein may be implemented in an operating environment comprising software installed on any programmable device, in hardware, or in a combination of software and hardware. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of receiving mitigation service provider recommendations, the method comprising:
providing a processor, a memory, and at least one sensor in a mobile computing device, wherein the memory and the at least one sensor are operatively coupled to the processor;
surveying features on and around a home by a user, using the mobile computing device, to identify mitigatable items;
determining, using the processor, mitigation work required to modify or remove the mitigatable items to reduce a wildfire risk associated with the home;
transmitting, to a computer system, information related to the mitigation work and a request for service providers to perform the mitigation work; and
receiving, from the computer system, information related to the service providers who are in a network associated with an insurance company operating the computer system, wherein the information includes a price for performing the mitigation work by the service providers in the network.

2. The method of claim 1 further comprising:
upon determining the required mitigation work, querying the user, through the mobile computing device, whether the user wants to hire the service providers in the network for the mitigation work; and
receiving an indication that the user wants to hire the service providers prior to transmitting the information related to the mitigation work and the request for the service provider to the computer system.

3. The method of claim 1 wherein the price for performing the mitigation work by the service providers in the network is at a discounted rate if the user has a mitigation insurance policy with the insurance company.

4. The method of claim 1 further comprising:
receiving an offer to purchase a mitigation insurance policy, at the mobile computing device, from the computer system if the user does not have the mitigation insurance policy with the insurance company;
transmitting, to the computer system, an indication that the user accepts the offer to purchase the mitigation insurance policy; and
receiving issuance of the mitigation insurance policy with an insurance premium.

5. The method of claim 1 wherein the method is performed through an application implemented on the mobile computing device to communicate with the computer system.

6. The method of claim 1 wherein the sensor is a camera incorporated in the mobile computing device and transmitted information related to the mitigation work includes one or more images of the mitigatable items captured by the camera.

7. A method of providing mitigation insurance for a home, the method comprising:
providing a computer system having a processor;
determining, using the processor, a user who is in need to perform mitigation work for a home to reduce a wildfire risk associated with the home;
accessing an insurance database to determine that the user does not have a mitigation insurance policy with an insurance company operating the computer system;
computing the wildfire risk associated with the home;
determining, using the processor, an amount of the mitigation work required to reduce the wildfire risk associated with the home below a threshold level;
computing, using the processor, a premium amount at least based on the amount of the mitigation work required and the wildfire risk associated with the home; and
providing an offer to purchase the mitigation insurance policy on the home to the user wherein the mitigation insurance policy provides a network of service providers who offer their services at a discounted rate.

8. The method of claim 7 wherein determining the user who is in need to perform the mitigation work comprises receiving information related to the mitigation work from the user through an application running on a user mobile computing device.

9. The method of claim 7 wherein the mitigation policy comprises a basic mitigation service.

10. The method of claim 7 wherein the premium amount is a variable premium amount which is adjusted periodically based on maintaining the mitigation work.

11. The method of claim 7 wherein the mitigation insurance policy is a rider to a homeowner's or renter's insurance policy.

12. The method of claim 7 further comprising providing a reward program comprising points for completing the mitigation work wherein the points are redeemable to purchase products or services.

13. The method of claim 7 wherein a portion of the premium amount is usable to pay for the mitigation work performed by the service providers.

14. The method of claim 7 further comprising:
receiving an indication of acceptance of the offer to purchase the mitigation insurance policy from the user; and
issuing the mitigation insurance policy with the premium amount.

15. A method of providing in-network service provider recommendations, the method comprising:
providing a computer system having a processor;
receiving information related to mitigation work from a user;
accessing, using the processor, a service provider database including service provider profiles, each of the service provider profiles being associated with each of service providers in a network associated with an insurance company operating the computer system;
determining, using the processor, a match between at least a portion of the information related to the mitigation work and a set of service provider profiles;
transmitting the information related to the mitigation work to a set of service providers having the matched set of service provider profiles;
receiving, from one or more of the set of service providers, an indication of availability to perform the mitigation work; and
providing, to the user, information related to the one or more of the set of service providers in the network.

16. The method of claim 15 further comprising:
determining that the user does not have a mitigation insurance policy;
computing a premium amount for the mitigation insurance policy based on the information related to the mitigation work; and
providing an offer to purchase the mitigation insurance policy with the premium amount, wherein the offer includes a discount rate for services performed by the one or more of the set of service providers in the network.

17. The method of claim 15 wherein the information related to the one or more of the set of service providers in the network includes a discount rate for services performed by the one or more of the set of service providers in the network if the user has an insurance policy with the insurance company.

18. The method of claim 17 wherein the insurance policy comprises a mitigation insurance policy with the insurance company.

19. The method of claim 17 further comprising:
receiving a report from the one or more of the set of services providers in the network that the mitigation work for the user has been completed; and
providing a discount on the premium amount of the mitigation insurance policy to the user for a predetermined period of time.

20. The method of claim 15 further comprising providing a reminder notification to the user to perform the mitigation work periodically.
